(19) United States
(12) Patent Application Publication
(10) Pub. No.: US 2021/0199579 A1
(43) Pub. Date: Jul. 1, 2021

(54) METHOD AND SYSTEM FOR URBAN IMPERVIOUS SURFACE EXTRACTION BASED ON REMOTE SENSING

(71) Applicants: Beijing Normal University, Beijing (CN); China Institute of Water Resources and Hydropower Research, Beijing (CN)

(72) Inventors: Adu GONG, Beijing (CN); Yanling CHEN, Beijing (CN); Yunhao CHEN, Beijing (CN); Tianjie LEI, Beijing (CN); Tingting ZENG, Beijing (CN); Yuqing YANG, Beijing (CN)

(21) Appl. No.: 17/035,113

(22) Filed: Sep. 28, 2020

(30) Foreign Application Priority Data
Dec. 31, 2019 (CN) 201911416291.1

(51) Int. Cl. G01N 21/55

(52) U.S. Cl. CPC G01N 21/55; G01N 2021/1797

(57) ABSTRACT

The present invention provides a method and system for urban impervious surface extraction based on remote sensing. The method includes: acquiring Landsat data; preprocessing the Landsat data to obtain preprocessed remotely sensed data; separately calculating an NDUI, an MNDWI, and a SAVI based on the remotely sensed data; stretching the NDUI, the MNDWI, and the SAVI to obtain a stretched NDUI, MNDWI, and SAVI; calculating an NDUII based on the stretched NDUI, MNDWI, and SAVI; and extracting impervious surface information by using a thresholding method based on the NDUII. The present invention can improve impervious surface extraction accuracy.

### CROSS-REFERENCE TO RELATED APPLICATIONS

This application claims the benefit under 35 U.S.C. § 119(a) and 37 CFR § 1.55 to Chinese patent application no. 201911416291.1 filed on Dec. 31, 2019 the entire content of which is incorporated herein by reference.

### BACKGROUND OF THE INVENTION

### Field of the Invention

The present invention relates to the field of impervious surface extraction based on remote sensing, and in particular, to a method and system for urban impervious surface extraction based on remote sensing.

### Description of the Related Technology

A conventional method for acquiring impervious surface information is manual surveying and mapping. This method is time-consuming, laborious, costly, and poor in real-time performance. With advantages such as rapid speed, large range, and multiscale, rapidly developing satellite remote sensing technologies overcome the disadvantages of the conventional method. An increasing number of methods for remote sensing inversion of impervious surface information are proposed. Existing study methods are mainly classified into the following five types: classification method, spectral mixture analysis (SMA) method, regression model method, decision tree model method, and spectrum-based index method. Currently, classification methods for impervious surface information mainly include the maximum likelihood algorithm, object-oriented method, artificial neural network (ANN) classification method, support vector machine (SVM), etc. All classification methods can be used to effectively extract impervious surfaces. However, these methods are limited when being applied to a larger area, for example, a large amount of data needs to be processed manually, a lot of time needs to be consumed, and computation is complicated. In addition, the mixed pixel problem cannot be well solved for medium-resolution optical images. The SMA method can effectively solve the mixed pixel problem. However, this method cannot be used to extract impervious surface information in large areas because of complicated computation and the difficulty in acquiring spectral characteristics of end members that represent pure pixels. Decision tree model methods include a regression-based analysis method and a rule-based method. The former is applicable to extraction of impervious surface information in large areas, but this method is extremely sensitive to data noise. The latter crucially depends on the quality of selected samples. Regression model methods include a vegetation-based method and an impervious-surface-based method. A regression relationship needs to be established with high-resolution information. This type of method is proved to be an effective method for extracting large-area impervious surfaces. However, the key to accuracy of impervious surface extraction is selecting an appropriate dependent variable from a low-resolution image and an appropriate independent variable from a high-spatial resolution image.

Compared with the above methods, the spectrum-based index method is highly operable and automated, and can be used to quickly extract impervious surface information in large areas. Therefore, it is now widely used. Scholars in and outside China enhanced the difference between impervious surfaces and other land cover types through band combination, and proposed a variety of built-up indices, including urban index (UI), normalized difference built-up index (NDBI), normalized difference impervious surface index (NDISI), enhanced built-up and bareness index (EBBI), normalized difference impervious index (NDII), modified NDISI (MNDISI), index-based built-up index (IBI), biophysical composition index (BCI), and combinational build-up index (CBI). All these indices can be used to extract impervious surface information, but certain limitations exist in the extraction process. A main problem is that the impervious surface information is often mixed with information about other ground feature types, especially bare soil. Based on Landsat 8 imagery, Liu Chang et al. tested extraction accuracy of eight major impervious surface indices (NDISI, BCI, UI, IBI, NDBI, NBI, PII, and RRI). The results showed that none of these eight indices could effectively address confusion between impervious surfaces and bare soil. For indices such as BCI and CBI, water body information needs to be removed before extracting impervious surface information. In addition, a thermal infrared band is required for indices such as NDISI. The thermal infrared band has a relatively low resolution. Although it plays a certain role in fusion and refinement in hybrid computation with multispectral bands, it still aggravates the phenomenon of mixed pixels. There is no thermal infrared band in many remotely sensed images, especially high-resolution images. Moreover, the MNDISI incorporates a rare high-resolution night light index, which limits its utility.

A city is a complex of a plurality of land cover types such as impervious surfaces, vegetation, water bodies, and bare soil. The spectral characteristic of bare soil is very close to that of impervious surfaces. Therefore, bare soil often interferes with extraction of impervious surface information. In addition, a plurality of methods for extracting impervious surface information are based on the vegetation-impervious surface-soil (V-I-S) model proposed by Ridd. In the model, a city is regarded as a linear combination of vegetation, impervious surfaces, and soil without considering water bodies. Therefore, in these methods, water body information needs to be masked in advance before extracting impervious surface information. This not only increases the workload, but also easily generates errors in a water body extraction process. In addition, the thermal infrared band is required for some indices such as NDISI and MNDISI, which aggravates the phenomenon of mixed pixels and reduces the accuracy in extracting permeable surface information.

### SUMMARY

An objective of the present invention is to provide a method and system for urban impervious surface extraction based on remote sensing, which can improve impervious surface extraction accuracy.

To achieve the above purpose, the present invention provides the following technical solutions.

A method for urban impervious surface extraction based on remote sensing includes:

acquiring Landsat data;

preprocessing the Landsat data to obtain preprocessed remotely sensed data;

separately calculating a normalized difference urban index (NDUI), a modified normalized difference water index (MNDWI), and a soil adjusted vegetation index (SAVI) based on the remotely sensed data;

stretching the NDUI, the MNDWI, and the SAVI to obtain a stretched NDUI, MNDWI, and SAVI;

calculating a normalized difference urban integrated index (NDUII) based on the stretched NDUI, MNDWI, and SAVI; and

extracting impervious surface information by using a thresholding method based on the NDUII.

Optionally, the preprocessing the Landsat data to obtain preprocessed remotely sensed data specifically includes:

performing radiometric calibration and atmospheric correction preprocessing on the Landsat data to obtain the preprocessed remotely sensed data, where the remotely sensed data includes blue reflectance, near infrared reflectance, reflectance of shortwave infrared 2, green reflectance, red reflectance, and reflectance of shortwave infrared 1.

Optionally, the calculating an NDUI, an MNDWI, and a SAVI based on the remotely sensed data specifically includes:

separately calculating the NDUI, the MNDWI, and the SAVI based on the remotely sensed data by using the following formulas:

$$NDUI = \frac{S W I R 2 - N I R + B L U E}{S W I R 2 + N I R + B L U E} , \\ MNDWI = \frac{G R E E N - S W I R 1}{G R E E N + S W I R 1} , and$$

$$SAVI = \frac{( S W I R 1 - R E D ) ( 1 + l )}{S W I R 1 + R E D + l} ,$$

where

BLUE denotes blue reflectance, NIR denotes near infrared reflectance, SWIR2 denotes reflectance of shortwave infrared 2, GREEN denotes green reflectance, RED denotes red reflectance, SWIR1 denotes reflectance of shortwave infrared 1, and denotes a soil adjustment factor.

Optionally, the calculating an NDUII based on the stretched NDUI, MNDWI, and SAVI specifically includes:

calculating the NDUII based on the stretched NDUI, MNDWI, and SAVI by using the formula

$$NDUII = \frac{N D U {I}^{*} + M N D W {I}^{*} - S A V {I}^{*}}{{NDUI}^{*} + {MNDWI}^{*} + {( SAV I )}^{*}} ,$$

where

NDUII denotes the normalized difference urban integrated index, NDUI* denotes the stretched NDUI, MNDWI* denotes the stretched MNDWI, and SAVI* denotes the stretched SAVI.

Optionally, the extracting impervious surface information by using a thresholding method based on the NDUII specifically includes:

determining a threshold by using a combination of visual interpretation and manual selection; and

binarizing the NDUII based on the threshold to obtain the impervious surface information.

A system for urban impervious surface extraction based on remote sensing includes:

a Landsat data acquiring module, configured to acquire Landsat data;

a preprocessing module, configured to preprocess the Landsat data to obtain preprocessed remotely sensed data;

an index calculation module, configured to separately calculate an NDUI, an MNDWI, and a SAVI based on the remotely sensed data;

a stretching module, configured to stretch the NDUI, the MNDWI, and the SAVI to obtain a stretched NDUI, MNDWI, and SAVI;

an NDUII calculation module, configured to calculate an NDUII based on the stretched NDUI, MNDWI, and SAVI; and

an extraction module, configured to extract impervious surface information by using a thresholding method based on the NDUII.

Optionally, the preprocessing module specifically includes:

a preprocessing unit, configured to perform radiometric calibration and atmospheric correction preprocessing on the Landsat data to obtain the preprocessed remotely sensed data, where the remotely sensed data includes blue reflectance, near infrared reflectance, reflectance of shortwave infrared 2, green reflectance, red reflectance, and reflectance of shortwave infrared 1.

Optionally, the index calculation module specifically includes: an index calculation unit, configured to separately calculate the NDUI, the MNDWI, and the SAVI based on the remotely sensed data by using the following formulas:

$$NDUI = \frac{S W I R 2 - N I R + B L U E}{S W I R 2 + N I R + B L U E} , \\ MNDWI = \frac{G R E E N - S W I R 1}{G R E E N + S W I R 1} , and$$

$$SAVI = \frac{( S W I R 1 - R E D ) ( 1 + l )}{S W I R 1 + R E D + l} ,$$

where

BLUE denotes blue reflectance, NIR denotes near infrared reflectance, SWIR2 denotes reflectance of shortwave infrared 2, GREEN denotes green reflectance, RED denotes red reflectance, SWIR1 denotes reflectance of shortwave infrared 1, and l denotes a soil adjustment factor.

Optionally, the NDUII calculation module specifically includes: an NDUII calculation unit, configured to calculate the NDUII based on the stretched NDUI, MNDWI, and SAVI by using the formula

$$NDUII = \frac{N D U {I}^{*} + M N D W {I}^{*} - S A V {I}^{*}}{N D U {I}^{*} + M N D W {I}^{*} + S A V {I}^{*}} ,$$

where

NDUII denotes the normalized difference urban integrated index, NDUI* denotes the stretched NDUI, MNDWI* denotes the stretched MNDWI, and SAVI* denotes the stretched SAVI.

Optionally, the extraction module specifically includes:

a threshold determining unit, configured to determine a threshold by using a combination of visual interpretation and manual selection; and

an extraction unit, configured to binarize the NDUII based on the threshold to obtain the impervious surface information.

According to specific examples provided in the present invention, the present invention discloses the following technical effects:

The present invention provides a method and system for urban impervious surface extraction based on remote sensing. The method includes: acquiring Landsat data; preprocessing the Landsat data to obtain preprocessed remotely sensed data; separately calculating a normalized difference urban index (NDUI), a modified normalized difference water index (MNDWI), and a soil adjusted vegetation index (SAVI) based on the remotely sensed data; stretching the NDUI, the MNDWI, and the SAVI to obtain a stretched NDUI, MNDWI, and SAVI; calculating a normalized difference urban integrated index (NDUII) based on the stretched NDUI, MNDWI, and SAVI; and extracting impervious surface information by using a thresholding method based on the NDUII. According to the present invention, the NDUII can be used to improve impervious surface extraction accuracy.

### BRIEF DESCRIPTION OF THE DRAWINGS

To describe the technical solutions in the examples of the present invention or in the prior art more clearly, the following briefly describes the accompanying drawings required for the examples. Apparently, the accompanying drawings in the following description show merely some examples of the present invention, and a person of ordinary skill in the art may still derive other accompanying drawings from these accompanying drawings without creative efforts.

FIG. 1 is a flowchart of a method for urban impervious surface extraction based on remote sensing according to the present invention;

FIG. 2 is a sketch map of study areas according to the present invention;

FIG. 3 is a diagram of spectral characteristics of four major land cover types in Beijing according to the present invention;

FIG. 4 is a diagram of comparison of different indices in Beijing, Johannesburg, and New York according to the present invention;

FIG. 5 shows histograms of different indices for different ground feature types in three study areas according to the present invention;

FIG. 6 shows binary maps of impervious surface indices in three study areas according to the present invention; and

FIG. 7 is a structural diagram of a system for urban impervious surface extraction based on remote sensing according to the present invention.

### DETAILED DESCRIPTION OF CERTAIN INVENTIVE EMBODIMENTS

The following clearly and completely describes the technical solutions in the examples of the present invention with reference to accompanying drawings in the examples of the present invention. Apparently, the described examples are merely a part rather than all of the examples of the present invention. All other examples obtained by a person of ordinary skill in the art based on the examples of the present invention without creative efforts shall fall within the protection scope of the present invention.

An objective of the present invention is to provide a method and system for urban impervious surface extraction based on remote sensing, which can improve impervious surface extraction accuracy.

In order to make the above objective, features, and advantages of the present invention more understandable, the present invention will be described in further detail below with reference to the accompanying drawings and detailed examples.

The present invention provides a new index, namely, normalized difference urban integrated index (NDUII) to enhance a characteristic difference between built-up lands and other ground feature types, thereby improving impervious surface extraction accuracy. Performance of the NDUII in impervious surface extraction was quantitatively analyzed by being compared with other indices. The results showed that the NDUII is a reliable and stable index that can be used for impervious surface extraction in different study areas, overcoming disadvantages of the above indices.

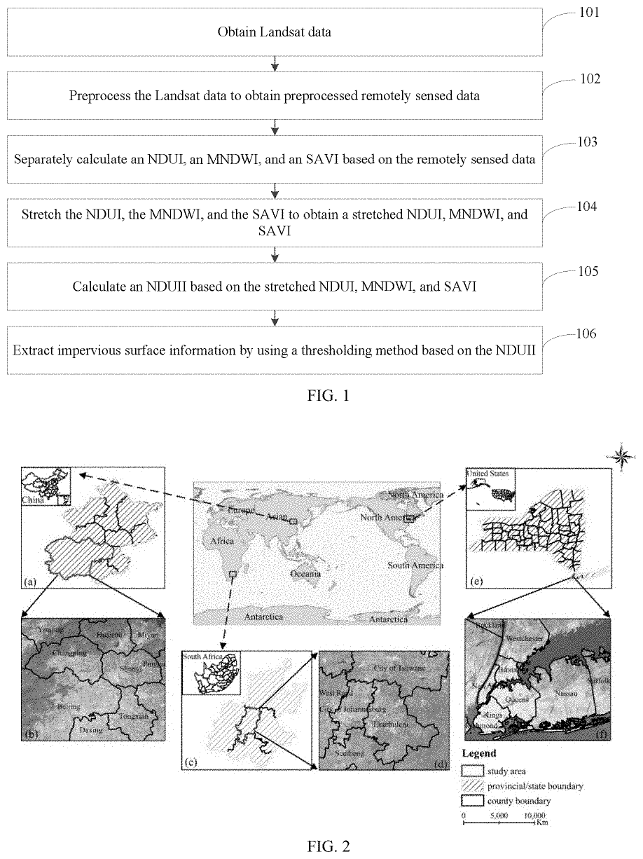

FIG. 1 is a flowchart of a method for urban impervious surface extraction based on remote sensing according to the present invention. As shown in FIG. 1, the method for urban impervious surface extraction based on remote sensing includes the following steps:

Step 101: obtain Landsat data. To analyze the applicability of the new index in different urban environments, three study areas, that is, Beijing in China, Johannesburg in South Africa, and New York in the United States were selected. FIG. 2 is a sketch map of study areas according to the present invention. Located in the North China Plain, Beijing is the capital of China, with a total area of 16410.54 km² and 16 municipal districts under its jurisdiction. Since the reform and opening up in 1978, Beijing has experienced explosive urbanization and population growth, with a population of 21,540,000 and an urbanization rate of 86.5% by 2018. Known as “the city of gold”, Johannesburg is the largest city and the economic, political, cultural, and tourist center in the Republic of South Africa. It is located in the high ground of the upper reaches of the Vaal River in northeastern South Africa, with an area of approximately 270 km² and an altitude of 1754 meters. New York, located on the Atlantic coast of southeastern New York State, is the largest city and port in the United States, with an area of 1,214 km² and a population of approximately 8.5 million. Land cover types in the three study areas include vegetation, impervious surfaces, water bodies, and bare lands. The major land cover types in Beijing are vegetation and impervious surfaces, with fewer water bodies and bare lands. Johannesburg has a large number of bare lands and fewer water bodies. New York has abundant water bodies and almost no bare soil with the rapid development of urbanization.

Widely used in analyses of dynamic changes in land cover types, Landsat data was selected and used in the present invention. Selected image dates were Aug. 13, 2009 (Beijing), Feb. 20, 2015 (Johannesburg), and Jul. 10, 2018 (New York). Landsat-7 ETM+images were used for Beijing, and Landsat-8 OLS images were used for Johannesburg and New York.

Step 102: preprocess the Landsat data to obtain preprocessed remotely sensed data, specifically including the following:

perform radiometric calibration and atmospheric correction preprocessing on the Landsat data to obtain the preprocessed remotely sensed data, where the remotely sensed data includes blue reflectance, near infrared reflectance, reflectance of shortwave infrared 2, green reflectance, red reflectance, and reflectance of shortwave infrared 1.

The Landsat-7 ETM+ scan line corrector (SLC) failed in May 2003, causing streaks in acquired images and loss of some data, which seriously affects normal use of the images. In response to this problem, some scholars carried out damage repair studies. In the present invention, the Landsat_gapfill plug-in is used to eliminate the streaks first. Then radiometric calibration and atmospheric correction are performed on each image to convert digital number (DN) values of all images to reflectance.

Step 103: separately calculate a normalized difference urban index (NDUI), a modified normalized difference water index (MNDWI), and a soil adjusted vegetation index (SAVI) based on the remotely sensed data, specifically including the following:

separately calculate the NDUI, the MNDWI, and the SAVI based on the remotely sensed data by using the following formulas:

$$NDUI = \frac{S W I R 2 - N I R + B L U E}{S W I R 2 + N I R + B L U E} , \\ MNDWI = \frac{G R E E N - S W I R 1}{G R E E N + S W I R 1} , and$$

$$SAVI = \frac{( S W I R 1 - R E D ) ( 1 + l )}{S W I R 1 + R E D + l} .$$

In the formulas, BLUE denotes blue reflectance, NIR denotes near infrared reflectance, SWIR2 denotes reflectance of shortwave infrared 2, GREEN denotes green reflectance, RED denotes red reflectance, SWIR1 denotes reflectance of shortwave infrared 1, and l denotes a soil adjustment factor is usually set to the empirical value 0.5. The following explains the NDUI, MNDWI, and SAVI:

NDUI: normalized difference urban index.

SAVI: soil adjusted vegetation index.

MNDWI: modified normalized difference water index.

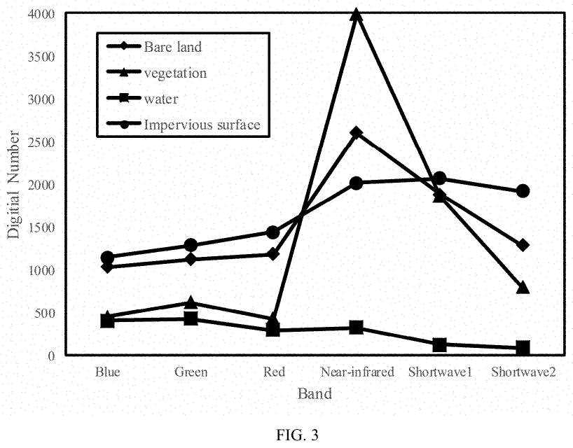

Since Rouse et al. created the normalized difference vegetation index (NDVI), scholars in and outside China developed a plurality of normalized difference indices, such as the normalized difference water index (NDWI) and the normalized difference built-up index (NDBI). These indices were created by finding bands with the strongest and weakest reflectance of land cover types that the scholars were interested in, and maximizing the contrast between the land cover types and background noise through a ratio algorithm. The NDBI was the most widely used normalized difference index for built-up land extraction. Zha Yong et al. found based on Landsat TM imagery that the grayscale value of built-up lands increased, whereas grayscale values of all other ground feature types decreased between TM4 and TMS. They created the NDBI based on this rule. The results showed that the NDBI did not perform well in impervious surface extraction, and water bodies and bare soil had great impact on impervious surface extraction. Therefore, the NDBI was improved in the present invention. FIG. 3 is a diagram of spectral characteristics of four major land cover types in Beijing according to the present invention. Using Beijing as an example, it could be known based on spectral characteristics of different ground feature types that the brightness differences between built-up lands, woodlands, cultivated lands, and bare soil in short-wave infrared 2 (SMIR2) were greater than the brightness differences in SMIR1. Therefore, SMIR1 was replaced with SMIR2. In addition, the brightness of built-up lands in terms of visible light was higher than that of other ground feature types. Based on this characteristic, a blue band was introduced to highlight built-up land information. Based on the above rule, a new index, namely, NDUI, was proposed.

Xu (2008) selected the NDBI, SAVI, and MNDWI to represent ground feature types and created the IBI based on the characteristic that urban land cover types were mainly impervious surfaces, vegetation, and water bodies. A plurality of studies showed that the IBI was an effective index for extracting urban built-up areas. The index used bands of three indices to replace original bands of images for the first time, which reduced the redundancy between the original bands. In the NDBI, it was easy to mix water body and bare soil information with impervious surface information, and the separability between water bodies and vegetation was low. In the NDUI, although water bodies, bare soil, and impervious surfaces still could not be completely separated, water bodies were completely separated from vegetation. Therefore, the NDUI was used instead of the NDBI to represent impervious surfaces. Table 1 shows statistics on four major urban land cover types in three new theme bands. To be specific, Table 1 shows means and standard deviations of four urban land use categories in three new theme images. In the NDUI band, the means of impervious surfaces and water bodies were significantly higher than the means of vegetation and bare lands, and the mean of water bodies was higher than that of impervious surfaces. In the MNDWI band, the mean of water bodies was a positive value, which was significantly higher than the means of the other three ground feature types. A combination of the NDUI and the MNDWI helped distinguish between impervious surfaces and water bodies. However, it was easy to confuse bare soil with impervious surfaces. Therefore, a SAVI band was introduced.

TABLE 1
Statistics on four major urban land cover
types of three new theme bands in Beijing

| Land cover type | Statistics | SAVI | NDUI | MNDWI |
|---|---|---|---|---|
| Vegetation | Mean | 1.210 | −0.383 | −0.505 |
| | Standard deviation | 0.060 | 0.086 | 0.085 |
| Impervious surface | Mean | 0.252 | 0.425 | −0.224 |
| | Standard deviation | 0.065 | 0.044 | 0.064 |
| Water body | Mean | 0.075 | 0.627 | 0.557 |
| | Standard deviation | 0.091 | 0.049 | 0.086 |
| Bare soil | Mean | 0.560 | 0.204 | −0.221 |
| | Standard deviation | 0.075 | 0.056 | 0.025 |

Step 104: stretch the NDUI, the MNDWI, and the SAVI to obtain a stretched NDUI, MNDWI, and SAVI. Here, values of the NDUI, MNDWI, and SAVI need to be stretched to the range of 0-255.

Step 105: calculate an NDUII based on the stretched NDUI, MNDWI, and SAVI, specifically including the following:

calculate the NDUII based on the stretched NDUI, MNDWI, and SAVI by using the formula

$$NDUII = \frac{N D U {I}^{*} + M N D W {I}^{*} - S A V {I}^{*}}{N {DUI}^{*} + MN {DWI}^{*} + {SAVI}^{*}} .$$

In the formula, NDUII ranges from −1 to 1, NDUI* denotes the stretched NDUI, MNDWI* denotes the stretched MNDWI, and SAVI* denotes the stretched SAVI.

Step 106: extract impervious surface information by using a thresholding method based on the NDUII, specifically including the following:

determine a threshold by using a combination of visual interpretation and manual selection; and

binarize the NDUII based on the threshold to obtain the impervious surface information. That is, a value within the threshold range in the NDUII was replaced with 1, and other parts were replaced with 0. In this way, the NDUII was divided into an impervious surface part (the part represented by 0) and a pervious surface part (the part represented by 1), thereby extracting the impervious surface information.

To evaluate performance of the NDUII in extracting impervious surface information in an urban environment, six commonly used spectral indices were selected for comparison, including the NDBI, UI, IBI, BCI, CBI, and NDISI. These spectral indices were calculated by using the following formulas:

$$N D B I = \frac{S W I R 1 - N I R}{S W I R 1 + N I R}$$

$$U I = \frac{S W I R 2 - N I R}{S W I R 2 + N I R}$$

$$BCI = \frac{( TC 1 + TC 3 ) / 2 - TC 2}{( TC 1 + TC 3 ) / 2 + TC 2}$$

$$CBI - \frac{( PC 1 + NDWI ) / 2 - SAVI}{( PC 1 + NDWI ) / 2 + SAVI}$$

$$IBI = \frac{NDBI - ( SAVI + MNDWI ) / 2}{NDBI + ( SAVI + MNDWI ) / 2}$$

$$NDWI = \frac{GREEN - NIR}{GREEN + NIR}$$

$$NDISI - \frac{TIR - ( MNDWI + NIR - SWIR 1 ) / 3}{TIR + ( MNDWI + NIR - SWIR 1 ) / 3}$$

In the formulas, GREEN denotes green reflectance, NIR denotes near infrared reflectance, SWIR1 denotes reflectance of shortwave infrared 1, SWIR2 denotes reflectance of short-wave infrared 2, TIR denotes reflectance of the thermal infrared band, TCᵢ(i=1,2,3) denotes the first three components of Tasseled Cap Transformation (TCT), and PC1 denotes the first component of the principal component analysis.

The spectral discrimination index (SDI) was used to quantitatively verify the discrimination [15, 30, 40, 41] between impervious surfaces, vegetation, water bodies, and bare soil in the extraction results of each index. The SDI measured the separability between two land cover types based on their relative positions and histogram distribution. Using the SDI to determine the separability between different land cover types mainly depended on two factors: a between-group variance and a within-group variance. The SDI was calculated by using the following formula:

$$SDI = \frac{\vert {μ}_{i} - {μ}_{s} \vert}{{σ}_{i} + {σ}_{s}}$$

In the formula, SDI denotes an SDI value of a certain index, μᵢ and μₛ denote means of two land cover types in the index, and σᵢ and σₛ denotes standard deviations of the two land cover types. If the SDI value of the index is less than 1, the index provides low separability between the two land cover types. If the SDI value is greater than 1, the separability is high. A larger value indicates higher separability.

Binary maps of impervious surfaces with different indices was generated by setting an appropriate threshold. Verification was performed by selecting sample points from Google Earth. A true positive rate (TPR), a false positive rate (FPR), and overall accuracy (OA) were used to represent the accuracy, error rate, and an overall condition of impervious surface extraction, which were calculated as follows:

$$TPR = \frac{T P}{TP + FN}$$

$$FPR = \frac{F P}{FP + TN}$$

$$OA = \frac{T P + T N}{TP + TN + FP + FN}$$

In the formulas, TP and TN respectively represent pixels that are correctly determined as an “impervious surface” pixel and a “pervious surface” pixel in the binary map. FP represents a “pervious surface” pixel wrongly determined as an “impervious surface” pixel. FN represents an “impervious surface” pixel wrongly determined as a “pervious surface” pixel.

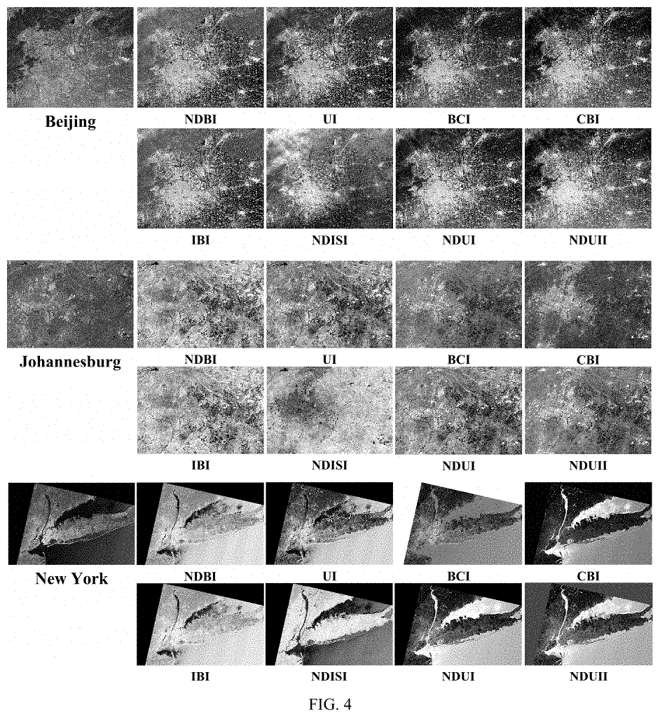

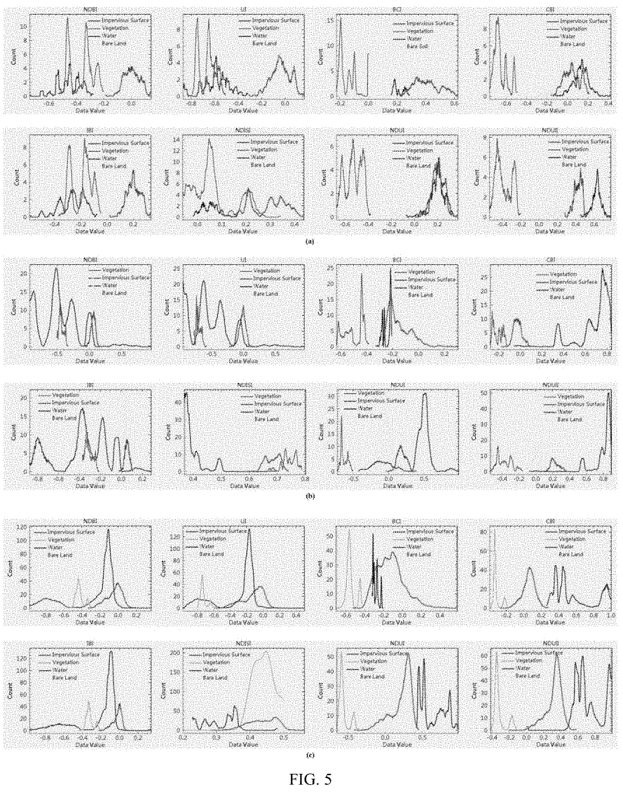

The NDUIIs of the three study areas were calculated based on Landsat imagery. A quantitative analysis was used to evaluate the performance of the NDUII in extracting impervious surface information in different urban environments. FIG. 4 is a diagram of comparison of different indices in Beijing, Johannesburg, and New York according to the present invention. It could be seen from FIG. 4 that the NDUII performed well in different study areas, and the overall distribution of impervious surface information was clear. Water bodies were presented in white with the largest value, especially in New York. Impervious surfaces were presented in light gray with the second largest value, including concrete roads and bright roofs that were clearly identified. With a value close to 0, bare soil was presented in medium gray and mainly distributed in rural and suburban areas (using Johannesburg as an example). In addition, vegetation was presented in dark gray and black with a negative value.

To quantitatively test the overall tendency of the NDUII, histograms of impervious surfaces and other ground feature types were drawn, and corresponding SDIs were calculated (as shown in FIG. 5 and Table 2). FIG. 5 shows histograms of different indices for different ground feature types in three study areas according to the present invention. Part (a) shows histograms of different indices for different ground feature types in Beijing. Part (b) shows histograms of different indices for different ground feature types in Johannesburg. Part (c) shows histograms of different indices for different ground feature types in New York. A first step for calculating the NDUII was to propose the NDUI based on the NDBI. Compared with the NDBI, the NDUI significantly increased the separability between impervious surfaces and vegetation. The SDI values were 2.032 (Beijing), 2.440 (Johannesburg), and 1.490 (New York). The separability between impervious surfaces and bare soil also increased slightly. Johannesburg had more bare soil information, and therefore its result was most representative. The SDI value increased from 0.053 to 0.585. However, the separability between impervious surfaces and water bodies decreased in Beijing and Johannesburg but increased in New York. This was probably because water bodies in New York were mostly seawater, whereas Beijing and Johannesburg had fewer water bodies, which were mostly lakes or ponds. The separability between other ground feature types increased greatly. To sum up, performance of the NDUI was better than that of the NDBI in enhancing impervious surface information. The SAVI and the MNDWI were added based on the NDUI to propose the NDUII . The results showed that the separability between ground feature types was high except that a very small amount of bare soil and water body information was mixed in impervious surface information.

TABLE 2
SDIs between different land cover types in different indices in the three study areas

| Study area | SDI | NDBI | UI | BCI | CBI | IBI | NDISI | NDUI | NDUII |
|---|---|---|---|---|---|---|---|---|---|
| Beijing | Imp&Veg | 0.972 | 1.606 | 1.448 | 1.845 | 1.094 | 0.569 | 2.032 | 2.241 |
| | Imp&Soi | 0.515 | 0.793 | 0.606 | 0.665 | 0.562 | 0.499 | 0.752 | 0.699 |
| | Imp&Wat | 1.214 | 1.239 | 0.550 | 0.225 | 1.214 | 0.743 | 0.012 | 0.662 |
| | Veg&Soi | 0.562 | 0.897 | 1.049 | 1.396 | 0.633 | 0.176 | 1.283 | 1.558 |
| | Veg&Wat | 0.221 | 0.181 | 1.171 | 2.086 | 0.163 | 0.046 | 1.974 | 2.749 |
| | Soi&Wat | 0.816 | 0.592 | 0.091 | 0.920 | 0.781 | 0.291 | 0.735 | 1.305 |
| Johannesburg | Imp&Veg | 1.800 | 2.310 | 0.872 | 0.639 | 1.499 | 0.248 | 2.440 | 1.619 |
| | Imp&Soi | 0.053 | 0.417 | 0.474 | 0.434 | 0.063 | 0.420 | 0.585 | 0.748 |
| | Imp&Wat | 0.858 | 0.844 | 0.283 | 1.591 | 0.795 | 1.040 | 0.311 | 1.344 |
| | Veg&Soi | 1.556 | 1.640 | 0.657 | 0.294 | 1.373 | 0.133 | 1.833 | 1.090 |
| | Veg&Wat | 0.017 | 0.317 | 0.781 | 1.980 | 0.098 | 1.243 | 1.747 | 2.516 |
| | Soi&Wat | 0.808 | 0.584 | 0.253 | 1.913 | 0.760 | 1.478 | 0.665 | 1.944 |
| New York | Imp&Veg | 1.000 | 1.288 | 0.839 | 0.925 | 0.951 | 0.065 | 1.490 | 1.349 |
| | Imp&Soi | 0.448 | 0.152 | 0.469 | 0.387 | 0.412 | 0.080 | 0.124 | 0.503 |
| | Imp&Wat | 0.112 | 0.002 | 0.203 | 0.761 | 0.170 | 0.440 | 0.754 | 0.706 |
| | Veg&Soi | 1.860 | 2.090 | 0.758 | 0.685 | 1.749 | 0.162 | 2.106 | 1.259 |
| | Veg&Wat | 0.688 | 1.293 | 1.022 | 1.578 | 0.536 | 0.399 | 2.619 | 2.219 |
| | Soi&Wat | 0.492 | 0.155 | 0.571 | 1.156 | 0.486 | 0.592 | 1.151 | 1.398 |

To verify the performance of the NDUII in extracting impervious surface information in the three study areas, six commonly used indices were selected for comparative analysis, including the NDBI, UI, BCI, CBI, IBI, and NDISI. FIG. 4 shows the calculation results. In addition, histograms of each index for all land cover types (as shown in FIG. 5) were drawn to evaluate the capability of each index to distinguish between impervious surfaces and other ground feature types. FIG. 3 shows SDI statistics results, which more visually represent the separability between various ground feature types. Moreover, some sample points were selected from Google Earth, and the TPR, FPR, and OA were calculated to verify accuracy of impervious surface information extracted based on each index (see Table 3).

Diagrams of all impervious surface indices in the three study areas were obtained based on Landsat imagery. It could be seen from FIG. 4 that the NDBI could well represent impervious surface information in Beijing, but it did not perform well in Johannesburg and New York. This conclusion could be reflected in the histograms and SDI statistics. In Beijing, the separability between impervious surfaces and water bodies and vegetation was relatively high, and the corresponding SDI values were 1.214 and 0.972 respectively. A small amount of bare soil information was mixed in impervious surface information, and the corresponding SDI value was 0.515. In Johannesburg, the value of the SDI between impervious surfaces and bare soil was only 0.053, indicating that the two were completely indistinguishable. In New York, the separability between impervious surfaces and water bodies was low, and the corresponding SDI value was only 0.112. In addition, it was easy to confuse vegetation information with water body information in the three study areas, and the corresponding SDI values were all less than 1. In conclusion, the NDBI exhibited low stability in representing impervious surface information, and was less effective in a study area with more water body and bare soil information. Basically the same as the effect of the NDBI, the effect of the UI was also the best in Beijing and worse in Johannesburg and New York. In addition, the IBI was developed by Xu et al. based on the NDBI, MNDWI, and SAVI. The histogram effect of the IBI was highly consistent with that of the NDBI, with low separability between impervious surfaces and bare soil and water bodies.

The BCI was created by Deng et al. based on TCT. Water bodies needed to be masked before using the BCI to extract impervious surface information. However, water bodies were not masked in this study, in order to analyze the separability between various land cover types. In the three study areas, the separability between impervious surfaces and water bodies and bare soil was low, and the corresponding SDI values were far less than 1. Water bodies had the greatest impact. In New York with a large number of water bodies, the value of the SDI between impervious surfaces and water bodies was only 0.203. Bare soil was also easily confused with impervious surfaces. The values of the SDI between impervious surfaces and water bodies in the three study areas were 0.606, 0.474, and 0.469, respectively. In addition, the separability between bare soil and water bodies was also low, and the corresponding SDI values were 0.091, 0.253, and 0.571. In conclusion, in the BCI, impervious surface information was greatly affected by water body and bare soil information, and masking water bodies in advance resulted in a heavy workload. In addition, it was difficult to completely remove water body information, which increased errors. In a study area with more bare soil, it is difficult to use the BCI to distinguish between impervious surfaces and bare soil. Therefore, the BCI is not suitable for a study area with a large amount of bare soil and water body information.

The CBI was proposed by Sun et al. based on the first principal component PC1, NDWI, and SAVI. Water bodies were not masked in advance for the CBI either in the present invention. In Beijing, the separability between water bodies and impervious surfaces was lower for the CBI compared with the BCI, and the SDI value was only 0.225, whereas the SDI value in Johannesburg was 1.591, and the SDI value in New York was 0.761. This indicated that interference from water bodies in impervious surfaces was unstable in the CBI. In addition, impervious surface extraction was greatly affected by bare soil in the CBI, similar to the BCI.

The NDISI failed to properly reflect the proportion and distribution of impervious surfaces in the three study areas. In Beijing and New York, values of SDIs between land cover types were all less than 1, indicating that vegetation, water bodies, and bare soil could all interfere with impervious surface extraction. However, the value of the SDI between water bodies and impervious surfaces was greater than 1 in Johannesburg, probably because Johannesburg had fewer water bodies with small impact.

Separability between various land use types was improved in the NDUII, compared with the above six indices. This indicated that there was less interference from other land cover types in the process of extracting impervious surface information. The separability between impervious surfaces and vegetation was high, and the SDI values in the three study areas were all greater than 1. Although impervious surfaces were still affected by bare soil, and the SDI values in the three study areas were all less than 1, the interference from bare soil in the NDUII was less than that in the other six indices. The value of the SDI between impervious surfaces and bare soil in the NDUII was the largest in Johannesburg and New York, and the second largest in Beijing after the UI. This indicated that the separability between impervious surfaces and bare soil was improved. Moreover, the interference from water bodies in impervious surfaces was also significantly reduced, especially in Johannesburg and New York, where the SDI value was significantly higher than other indices except the CBI. In addition, the values of SDIs between other land cover types were all greater than 1.

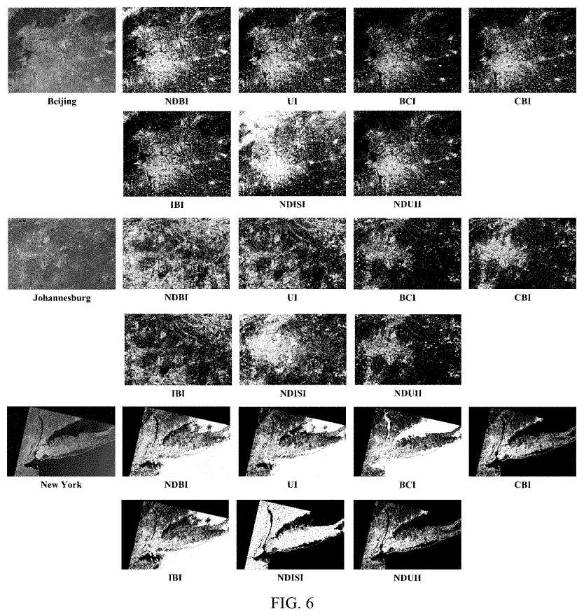

Based on the statistical results of separability between land use types in each index, thresholds for extracting impervious surface information were given to obtain binary maps of impervious surfaces extraction in the three study areas. FIG. 6 shows binary maps of impervious surface indices in the three study areas according to the present invention. Some sample points were selected from Google Earth to verify the accuracy of impervious surface information extracted by using each index. Table 3 shows the results.

TABLE 3
Extraction accuracy of impervious surface indices

| Imper- | | | | | | | | | |
|---|---|---|---|---|---|---|---|---|---|
| vious | | | | | | | | | |
| surface | Beijing | | | Johannesburg | | | New York | | |
| index | TPR | FPR | OAs | TPR | FPR | OA | TPR | FPR | OA |
| NDBI | 0.942 | 0.031 | 0.955 | 0.727 | 0.321 | 0.712 | 0.728 | 0.063 | 0.811 |
| UI | 0.979 | 0.049 | 0.965 | 0.794 | 0 | 0.844 | 0.769 | 0.102 | 0.829 |
| BCI | 0.975 | 0.176 | 0.885 | 0.940 | 0.099 | 0.924 | 0.681 | 0.022 | 0.779 |
| CBI | 0.911 | 0.071 | 0.920 | 0.945 | 0.124 | 0.916 | 0.962 | 0.020 | 0.971 |
| IBI | 0.979 | 0.067 | 0.955 | 0.785 | 0.192 | 0.729 | 0.777 | 0.009 | 0.864 |
| NDISI | 0.805 | 0.013 | 0.875 | 0.831 | 0.090 | 0.856 | 0.557 | 0.221 | 0.618 |
| NDUII | 0.979 | 0.075 | 0.950 | 0.980 | 0.020 | 0.980 | 0.962 | 0.020 | 0.971 |

The accuracy of each index was above 0.85 in Beijing. The UI had the highest OA of impervious surface extraction, which was 0.965, and the best extraction effect. This was because the UI had the highest TPR, which indicated that the UI delivered higher accuracy in impervious surface extraction. Both the accuracy of the NDBI and that of the IBI reached 0.955, after the UI. The NDUII proposed in the present invention also achieved a good extraction effect, with an OA value of 0.950. The TPR of the NDUII was the same as that of the UI, but the FPR of the NDUII is slightly higher than that of the UI. The NDISI had the poorest extraction effect and the lowest TPR (0.805) because some vegetation information interfered in impervious surface information. The BCI also delivered poor extraction accuracy (0.885), and it had a relatively high TPR and the highest FPR (0.176). It could be seen from FIG. 6 that impervious surface information was ignored in the BCI. The OA value of the CBI was 0.920. It could be known from the SDI statistics that there was more interference from water bodies in the CBI than in other indices.

In Johannesburg, the impervious surface extraction accuracy of the BCI, CBI, and NDUII were relatively high, and the corresponding OA values were 0.940, 0.945, and 0.980, respectively. Among the three indices, the NDUII had the best extraction effect. The reason was that, compared with the BCI and the CBI, the NDUII had a higher TPR and a lower FPR, and separability between various ground feature types was higher, whereas impervious surface information was easily affected by water body information in the BCI and CBI. The NDBI and IBI had the worst extraction effect, with corresponding OA values less than 0.75. The main reasons for their poor performance were high FPR values (0.321 and 0.192) and a large amount of bare soil and water body information mixed in impervious surface information. Impervious surfaces was greatly affected by vegetation and bare soil in the NDISI. Therefore, the OA (0.856) of the NDISI is relatively low. These conclusions were supported by histogram analyses of impervious surfaces and other feature types. In conclusion, the NDUII was suitable for areas with more bare soil, such as Johannesburg.

In New York, OA values of the CBI and NDUII in impervious surface extraction are 0.971, which was much higher than OA values of other indices. Extraction accuracy of the NDBI, UI, BCI, and IBI index was relatively low. It could be seen from FIG. 6 that a large amount of water body information was mixed in impervious surface information. Therefore, the corresponding TPRs were all low. In the extraction results of the NDISI, vegetation was not distinguished from impervious surfaces. Therefore, the NDISI had the lowest TPR (0.557) and the highest FPR (0.221). The NDUII was suitable for study areas with more water bodies, such as New York.

In conclusion, the NDUII performed more stably in extracting impervious surface information, and OA values of the NDUII in the three study areas were all greater than 0.95. This indicated that the NDUII was suitable for different types of study areas. In contrast, the other six indices were applicable only to specific types of study areas. The NDBI, UI, and IBI were applicable to areas with few bare lands and water bodies such as Beijing, and could reduce the interference in impervious surface information. The BCI was applicable to areas with few water bodies; otherwise, water bodies needed to be masked in advance. The NDISI was applicable to no area, especially study areas with abundant water bodies, such as New York. The CBI performed well in all study areas, but its accuracy was lower than that of the NDUII.

It could be seen from the above conclusions that the NDUII provided in the present invention was a convenient and effective method for distinguishing impervious surfaces from other urban land cover types, especially bare soil. Many studies showed that as a heterogeneous feature, an index including original multispectral bands could not be used to effectively extract impervious surface information. As an improvement based on the IBI, the NDUII included bands of three thematic indices: SAVI, MNDWI, and NDUI. It could greatly reduce the redundancy between the original bands and avoid the spectrum confusion between different land cover types. Different from the IBI, the NDUII used the NDUI rather than the NDBI to represent impervious surface information. The results showed that the accuracy of the NDUII was significantly higher than that of the IBI in extracting impervious surface information. This was because a blue band was added for the NDUI on the basis of the NDBI, which improved the separability between impervious surfaces and bare soil. In addition, the SAVI was added to further enhance the separability between impervious surfaces and bare soil.

Another advantage of the NDUII was that it exhibited high accuracy in different study areas, and its stability was better than other indices. The above results showed that all the seven indices had high accuracy and the OA values were greater than 0.85 in Beijing where the major land cover type was impervious surfaces, and there were few water bodies and bare soil. However, the indices performed differently in Johannesburg and New York. The NDBI, UI and IBI had the highest extraction accuracy in Beijing, but their accuracy in Johannesburg and New York was greatly reduced, especially in Johannesburg. In the three study areas, the NDISI had the lowest accuracy, especially in New York with abundant water bodies. The BCI and CBI were greatly affected by water bodies. Therefore, water bodies usually needed to be masked in advance. In contrast, the NDUII was a convenient and stable index. However, because it was difficult to completely distinguish between imperviousness and semi-imperviousness of rocks, a small amount of bare soil information was still mixed in impervious surface information.

The NDUII followed the V-I-S model and enhanced the separability between impervious surfaces and other land cover types. The NDUI was first proposed based on the NDBI, and then the NDUI, SAVI, and MNDWI were used to construct the NDUII, instead of using the original image bands. Visual and statistical analyses results showed that the NDUII performed better than other commonly used indices (NDBI, UI, BCI, CBI, IBI, and NDISI) in different study areas. The NDUII achieved a good effect in distinguishing bare lands from impervious surfaces, and was applicable to study areas in different urban environments. Another advantage of the NDUII was that water body information did not need to be masked in advance, which greatly reduced errors and workload. In addition, calculation of the NDUII did not depend on a TIR band with low spatial resolution. This avoided mixed pixels and improved impervious surface extraction accuracy.

The results showed that construction of the NDUII could effectively reduce data dimensions and redundancy of images, thereby avoiding inter-category variation. This overcame confusion between impervious surfaces, bare soil, and water bodies. Therefore, the NDUII provided a simple and convenient method for extracting impervious surface information, which was beneficial to land use management.

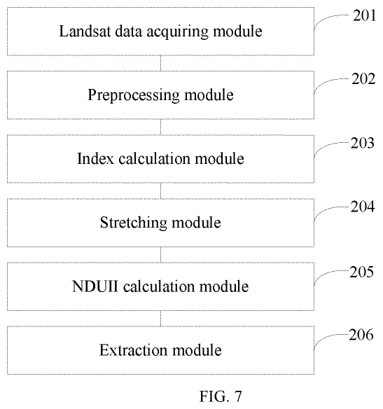

FIG. 7 is a structural diagram of a system for urban impervious surface extraction based on remote sensing according to the present invention. The system for urban impervious surface extraction based on remote sensing includes:

a Landsat data acquiring module 201, configured to acquire Landsat data;

a preprocessing module 202, configured to preprocess the Landsat data to obtain preprocessed remotely sensed data;

an index calculation module 203, configured to separately calculate an NDUI, an MNDWI, and a SAVI based on the remotely sensed data;

a stretching module 204, configured to stretch the NDUI, the MNDWI, and the SAVI to obtain a stretched NDUI, MNDWI, and SAVI;

an NDUII calculation module 205, configured to calculate an NDUII based on the stretched NDUI, MNDWI, and SAVI; and

an extraction module 206, configured to extract impervious surface information by using a thresholding method based on the NDUII.

The preprocessing module 202 specifically includes:

a preprocessing unit, configured to perform radiometric calibration and atmospheric correction preprocessing on the Landsat data to obtain the preprocessed remotely sensed data, where the remotely sensed data includes blue reflectance, near infrared reflectance, reflectance of shortwave infrared 2, green reflectance, red reflectance, and reflectance of shortwave infrared 1.

The index calculation module 203 specifically includes:

an index calculation module, configured to separately calculate the NDUI, the MNDWI, and the SAVI based on the remotely sensed data by using the following formulas:

$$N D U I = \frac{S W I R 2 - N I R + B L U E}{S W I R 2 + N I R + B L U E} , \\ MNDWI = \frac{G R E E N - S W I R 1}{G R E E N + S W I R 1} , and$$

$$SAVI = \frac{( S W I R 1 - R E D ) ( 1 + l )}{S W I R 1 + R E D + l} .$$

In the formulas, BLUE denotes blue reflectance, NIR denotes near infrared reflectance, SWIR2 denotes reflectance of shortwave infrared 2, GREEN denotes green reflectance, RED denotes red reflectance, SWIR1 denotes reflectance of shortwave infrared 1, and l denotes a soil adjustment factor.

The NDUII calculation module 205 specifically includes: an NDUII calculation unit, configured to calculate the NDUII based on the stretched NDUI, MNDWI, and SAVI by using the formula

$$NDUII = \frac{N D U {I}^{*} + M N D W {I}^{*} - S A V {I}^{*}}{N {DUI}^{*} + MN {DWI}^{*} + {SAVI}^{*}} .$$

In the formula, NDUII denotes the normalized difference urban integrated index, NDUI* denotes the stretched NDUI, MNDWI* denotes the stretched MNDWI, and SAVI* denotes the stretched SAVI.

The extraction module 206 specifically includes:

a threshold determining unit, configured to determine a threshold by using a combination of visual interpretation and manual selection; and

an extraction unit, configured to binarize the NDUII based on the threshold to obtain the impervious surface information.

Each example of the present specification is described in a progressive manner, each example focuses on the difference from other examples, and the same and similar parts between the examples may refer to each other. For a system disclosed in the examples, since it corresponds to the method disclosed in the examples, the description is relatively simple, and reference can be made to the method description.

In this specification, several examples are used for illustration of the principles and implementations of the present invention. The description of the foregoing examples is used to help illustrate the method of the present invention and the core principles thereof. In addition, those of ordinary skill in the art can make various modifications in terms of specific implementations and scope of application in accordance with the teachings of the present invention. In conclusion, the content of the present specification shall not be construed as a limitation to the present invention.

What is claimed is:

1. A method for urban impervious surface extraction based on remote sensing, comprising:
acquiring Landsat data;
preprocessing the Landsat data to obtain preprocessed remotely sensed data;
separately calculating a normalized difference urban index (NDUI), a modified normalized difference water index (MNDWI), and a soil adjusted vegetation index (SAVI) based on the remotely sensed data;
stretching the NDUI, the MNDWI, and the SAVI to obtain a stretched NDUI, MNDWI, and SAVI;
calculating a normalized difference urban integrated index (NDUII) based on the stretched NDUI, MNDWI, and SAVI; and
extracting impervious surface information by using a thresholding method based on the NDUII.

2. The method for urban impervious surface extraction based on remote sensing according to claim 1, wherein the preprocessing the Landsat data to obtain preprocessed remotely sensed data specifically comprises:
performing radiometric calibration and atmospheric correction preprocessing on the Landsat data to obtain the preprocessed remotely sensed data, wherein the remotely sensed data comprises blue reflectance, near infrared reflectance, reflectance of shortwave infrared 2, green reflectance, red reflectance, and reflectance of shortwave infrared 1.

3. The method for urban impervious surface extraction based on remote sensing according to claim 1, wherein the calculating an NDUI, an MNDWI, and a SAVI based on the remotely sensed data specifically comprises:
separately calculating the NDUI, the MNDWI, and the SAVI based on the remotely sensed data by using the following formulas:
$$NDUI = \frac{S W I R 2 - N I R + B L U E}{S W I R 2 + N I R + B L U E} , \\ MNDWI = \frac{G R E E N - S W I R 1}{G R E E N + S W I R 1} , and$$
$$SAVI = \frac{( S W I R 1 - R E D ) ( 1 + l )}{S W I R 1 + R E D + l} ,$$
wherein
BLUE denotes blue reflectance, NIR denotes near infrared reflectance, SWIR2 denotes reflectance of shortwave infrared 2, GREEN denotes green reflectance, RED denotes red reflectance, SWIR1 denotes reflectance of shortwave infrared 1, and l denotes a soil adjustment factor.

4. The method for urban impervious surface extraction based on remote sensing according to claim 1, wherein the calculating an NDUII based on the stretched NDUI, MNDWI, and SAVI specifically comprises:
calculating the NDUII based on the stretched NDUI, MNDWI, and SAVI by using the formula
$$NDUII = \frac{N D U {I}^{*} + M N D W {I}^{*} - S A V {I}^{*}}{N D U {I}^{*} + M N D W {I}^{*} + S A V {I}^{*}} ,$$
wherein
NDUII denotes the normalized difference urban integrated index, NDUI* denotes the stretched NDUI, MNDWI* denotes the stretched MNDWI, and SAVI* denotes the stretched SAVI.

5. The method for urban impervious surface extraction based on remote sensing according to claim 1, wherein the extracting impervious surface information by using a thresholding method based on the NDUII specifically comprises:
determining a threshold by using a combination of visual interpretation and manual selection; and
binarizing the NDUII based on the threshold to obtain the impervious surface information.

6. A system for urban impervious surface extraction based on remote sensing, comprising:
a Landsat data acquiring module, configured to acquire Landsat data;
a preprocessing module, configured to preprocess the Landsat data to obtain preprocessed remotely sensed data;
an index calculation module, configured to separately calculate an NDUI, an MNDWI, and a SAVI based on the remotely sensed data;
a stretching module, configured to stretch the NDUI, the MNDWI, and the SAVI to obtain a stretched NDUI, MNDWI, and SAVI;
an NDUII calculation module, configured to calculate an NDUII based on the stretched NDUI, MNDWI, and SAVI; and
an extraction module, configured to extract impervious surface information by using a thresholding method based on the NDUII.

7. The system for urban impervious surface extraction based on remote sensing according to claim 6, wherein the preprocessing module specifically comprises:
a preprocessing unit, configured to perform radiometric calibration and atmospheric correction preprocessing on the Landsat data to obtain the preprocessed remotely sensed data, wherein the remotely sensed data comprises blue reflectance, near infrared reflectance, reflectance of shortwave infrared 2, green reflectance, red reflectance, and reflectance of shortwave infrared 1.

8. The system for urban impervious surface extraction based on remote sensing according to claim 6, wherein the index calculation module specifically comprises:
an index calculation unit, configured to separately calculate the NDUI, the MNDWI, and the SAVI based on the remotely sensed data by using the following formulas:
$$NDUI = \frac{S W I R 2 - N I R + B L U E}{S W I R 2 + N I R + B L U E} , \\ MNDWI = \frac{G R E E N - S W I R 1}{G R E E N + S W I R 1} , and$$
$$SAVI = \frac{( S W I R 1 - R E D ) ( 1 + l )}{S W I R 1 + R E D + l} ,$$
wherein
BLUE denotes blue reflectance, NIR denotes near infrared reflectance, SWIR2 denotes reflectance of shortwave infrared 2, GREEN denotes green reflectance, RED denotes red reflectance, SWIR1 denotes reflectance of shortwave infrared 1, and l denotes a soil adjustment factor.

9. The system for urban impervious surface extraction based on remote sensing according to claim 6, wherein the NDUII calculation module specifically comprises:
an NDUII calculation unit, configured to calculate the NDUII based on the stretched NDUI, MNDWI, and SAVI by using the formula
$$NDUII = \frac{N D U {I}^{*} + M N D W {I}^{*} - S A V {I}^{*}}{N D U {I}^{*} + M N D W {I}^{*} + S A V {I}^{*}} ,$$
wherein
NDUII denotes the normalized difference urban integrated index, NDUI* denotes the stretched NDUI, MNDWI* denotes the stretched MNDWI, and SAVI* denotes the stretched SAVI.

10. The system for urban impervious surface extraction based on remote sensing according to claim 6, wherein the extraction module specifically comprises:
a threshold determining unit, configured to determine a threshold by using a combination of visual interpretation and manual selection; and
an extraction unit, configured to binarize the NDUII based on the threshold to obtain the impervious surface information.
